(19) United States
(12) Patent Application Publication
(10) Pub. No.: US 2023/0108570 A1
(43) Pub. Date: Apr. 6, 2023

(54) CROSSMEMBER ASSEMBLY FOR AN ADJUSTABLE ROOF RACK OF A MOTOR VEHICLE

(71) Applicant: PLASMAN US HOLDCO LLC, Oldcastle (CA)

(72) Inventors: Luca Robert Barberis, Rochester, MI (US); Imtiaz Syed, Lake Orion, MI (US)

(21) Appl. No.: 17/493,238

(22) Filed: Oct. 4, 2021

(51) Int. Cl. B60R 9/045; B60R 9/052; B60R 9/058

(52) U.S. Cl. CPC B60R 9/045; B60R 9/052; B60R 9/058

(57) ABSTRACT

A crossmember assembly is provided for a motor vehicle having a roof with first and second rails. Each rail has a width within a range of widths, with the first and second rails being spaced from one another by distance within a range of distances. The assembly includes a crossbar having first and second ends and movable along the rails. The assembly further includes a first clamp mechanism engaged with the first end for securing the crossbar to the first rail and a second clamp mechanism engaged with the second end for securing the crossbar to the first rail. Each of the first and second clamp mechanisms includes a stanchion attached to the crossbar and having a first rail gripping surface. Each of the first and second clamp mechanisms further includes an actuator having a second rail gripping surface that is movable between unclamped and clamped positions.

### FIELD

The present disclosure relates to roof racks of motor vehicles, and more particularly, to a crossmember assembly that is movable along a pair of rails and has clamp mechanisms for holding the crossmember assembly in a fixed position on the rails.

### BACKGROUND

Modern vehicles have roof racks for increasing the cargo capacity of the vehicles. Non-limiting examples of cargo attached to roof racks can include skis, snowboards, bikes, cargo cages, or cargo containers. The roof rack can include two rails and multiple crossbars extending between the rails at fixed positions along the rails. The width of each rail and the distance between the rails can vary among vehicles of different makes, models, or production years. For that reason, each crossbar can have a fixed length and shape for attachment to only the rails on vehicles of specific makes, models, and production years.

In certain circumstances, it may be desirable to adjust the distance between crossbars to support cargo having a corresponding length. However, because the rails may not be parallel with one another, the crossbar may not be long enough to attach to sections of opposing rails that are spaced from one another by a distance longer than the fixed length of the crossbar.

Accordingly, there is a need in the art for a crossmember assembly that allows a crossbar to be attached to rails having one of a range of widths and spaced from one another by one of a range of distances.

### SUMMARY

According to several aspects, a crossmember assembly is provided for a motor vehicle having a roof with first and second rails attached to the roof. Each of the first and second rails has a width within a range of widths, and the first and second rails are spaced from one another by a distance within a range of distances. The assembly includes a crossbar having first and second ends along an axis. The assembly further includes a first clamp mechanism engaged with the first end of the crossbar for securing the crossbar to the first rail and a second clamp mechanism engaged with the second end of the crossbar for securing the crossbar to the second rail. Each of the first and second clamp mechanisms includes a stanchion, which is attached to the crossbar and has a first rail gripping surface. Each of the first and second clamp mechanisms further includes an actuator having a second rail gripping surface. The actuator is movable relative to the stanchion between a clamped position where the first and second rail gripping surfaces of the first and second clamp mechanisms grip an associated one of the first and second rails and an unclamped position where the second rail gripping surface is spaced from an associated one of the first and second rails.

In one aspect, the actuator includes a cam body pivotably attached to the stanchion. The cam body is movable between the unclamped position where the stanchion urges the cam body in a downward direction and the clamped position where the stanchion urges the cam body in an upward direction. The actuator further includes a tongue, which is pivotably attached to the cam body and has the second rail gripping surface. The tongue is adapted to be positioned within an open channel formed in an associated one of the first and second rails, with the first and second rail gripping surfaces of the first and second clamp mechanisms capable of gripping an associated one of the first and second rails therebetween to secure the crossbar in a fixed position relative to the first and second rails.

In another aspect, the stanchion defines a pair of grooves, and the actuator further includes a pin having a pair of opposing ends that are received in an associated one of the grooves. The cam body is pivotably attached to the stanchion via the pin, and the pin is movable relative to the stanchion between an upper position and a lower position.

In another aspect, at least one of the first and second clamp mechanisms is movable along the axis of the crossbar, such that the crossbar is capable of mounting to the first and second rails that are spaced from one another by the distance within the range of distances.

In another aspect, at least one of the crossbar and the stanchion of the first and second clamp mechanisms defines a slot extending along the axis of the crossbar such that a fastener is received through the slot to hold the first and second clamp mechanisms at the distance within the range of distances from one another.

In another aspect, each of the first and second clamp mechanisms further includes a modular pad attached to the stanchion for gripping an associated one of the first and second rails.

In another aspect, each of the first and second clamp mechanisms further includes a lock attached to the cam body. The lock is movable between a locked position where the lock holds the cam body in the clamped position relative to the stanchion and an unlocked position where the cam body is movable between the clamped and unclamped positions.

According to several aspects, an adjustable roof rack is provided for a motor vehicle having a roof. The adjustable roof rack includes first and second rails attached to the roof, with each of the first and second rails having a width within a range of widths and spaced from one another by a distance within a range of distances. The adjustable roof rack includes a crossmember assembly having a crossbar with first and second ends along an axis. The assembly further includes a first clamp mechanism engaged with the first end of the crossbar for securing the crossbar to the first rail and a second clamp mechanism engaged with the second end of the crossbar for securing the crossbar to the second rail. Each of the first and second clamp mechanisms includes a stanchion, which is attached to the crossbar and has a first rail gripping surface. Each of the first and second clamp mechanisms further includes an actuator having a second rail gripping surface. The actuator is movable relative to the stanchion between a clamped position where the first and second rail gripping surfaces of the first and second clamp mechanisms grip an associated one of the first and second rails and an unclamped position where the second rail gripping surface is spaced from an associated one of the first and second rails.

In one aspect, each of the first and second rails is an extrusion defining an open channel extending toward a pair of opposing ends.

In another aspect, each of the first and second rails includes a pair of caps attached to an associated one of the opposing ends to block the open channel.

In another aspect, the actuator includes a cam body pivotably attached to the stanchion and movable between the unclamped position where the stanchion urges the cam body in a downward direction and the clamped position where the stanchion urges the cam body in an upward direction. The actuator further includes a tongue pivotably attached to the cam body and having the second rail gripping surface, with the tongue adapted to be positioned within the open channel formed in an associated one of the first and second rails. The first and second rail gripping surfaces of the first and second clamp mechanisms are capable of gripping an associated one of the first and second rails therebetween to secure the crossbar in a fixed position relative to the first and second rails.

In another aspect, the stanchion defines a pair of grooves, and the actuator further includes a pin having a pair of opposing ends that are received in an associated one of the grooves. The cam body is pivotably attached to the stanchion via the pin, and the pin is movable relative to the stanchion between an upper position and a lower position.

In another aspect, at least one of the first and second clamp mechanisms is movable along the axis of the crossbar, such that the crossbar is capable of mounting to the first and second rails that are spaced from one another by the distance within the range of distances.

In another aspect, at least one of the crossbar and the stanchion of the first and second clamp mechanisms defines an elongated slot extending along the axis of the crossbar such that a fastener is received through the elongated slot to hold the first and second clamp mechanisms at the distance within the range of distances from one another.

In another aspect, each of the first and second clamp mechanisms further includes a modular pad attached to the stanchion for gripping an associated one of the first and second rails.

In another aspect, each of the first and second clamp mechanisms further includes a lock attached to the cam body. The lock is movable between a locked position where the lock holds the cam body in the clamped position relative to the stanchion and an unlocked position where the cam body is movable between the clamped and unclamped positions.

According to several aspects, a process is provided for operating a crossmember assembly of an adjustable roof rack of a motor vehicle having a roof. The adjustable roof rack includes first and second rails attached to the roof. Each of the first and second rails has a width within a range of widths, and the first and second rails are spaced from one another by a distance within a range of distances. The adjustable roof rack further includes a crossmember assembly having a crossbar and first and second clamp mechanisms. The crossbar has first and second ends along an axis, and each of the first and second clamp mechanisms are engaged with an associated one of the first and second ends. Each of the first and second clamp mechanisms includes a stanchion with a first rail gripping surface and an actuator with a second rail gripping surface. The process includes moving the actuator of each of the first and second clamp mechanisms from a clamped position to an unclamped position relative to the stanchion. The second rail gripping surface of the first and second clamp mechanisms is spaced from an associated on of the first and second rails, in response to the actuator moving to the unclamped position. The crossbar is moved from a first position to a second position along the first and second rails. The actuator of each of the first and second clamp mechanisms is moved from the unclamped position to the clamped position, in response to the crossbar moving to the second position. The first and second rail gripping surfaces of the first and second clamp mechanisms grip an associated one the first and second rails to hold the crossbar in the second position, in response to the actuator moving to the clamped position.

In one aspect, a cam body of each actuator pivots between the unclamped position and the clamped position. A tongue, which is attached to the cam body and has the second rail gripping surface, is positioned within an open channel formed in an associated one of the first and second rails. The second rail gripping surface is spaced from the associated first and second rails when the actuator is disposed in the unclamped position. The first and second rail gripping surfaces of an associated one the first and second rails grip an associated one of the first and second rails therebetween when the actuator is disposed in the clamped position.

In another aspect, the process further includes pivoting the cam body on a pin between the unclamped position and the clamped position, with the pin having a pair of opposing ends disposed in a pair of associated grooves formed in the stanchion. The pin and the cam body move to an upper position along the grooves, in response to the cam body pivoting to the clamped position. The first and second rail gripping surfaces of the first and second clamp mechanisms grips an associated one of the first and second rails, in response to the pin being disposed in the upper position. The pin and the cam body move to a lower position along the grooves, in response to the cam body pivoting to the unclamped position. The second rail gripping surface of the first and second clamp mechanisms is spaced from an associated one of the first and second rails, in response to the pin being disposed in the lower position.

In another aspect, the process further includes moving a lock, which is attached to the cam body and movable between an unlocked position and a locked position where the lock holds the cam body in the clamped position.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

FIG. 1 is a perspective view of one example of a motor vehicle having a roof with two rails and two crossmember assemblies, illustrating each assembly having first and second clamp mechanisms attaching a crossbar to the rails.

FIG. 2 is a top plan view of a portion of the roof of FIG. 1, illustrating each of the crossmember assemblies being movable along the rails.

FIG. 3 is a side view of one of the rails of FIG. 2, illustrating a side profile of the roof and one of the rails having a downwardly curving slope.

FIG. 4 is an exploded perspective view of the first clamp mechanism for one of the assemblies of FIG. 1.

FIG. 5 is a cross-sectional view of the first clamp mechanism of FIG. 2 as taken along line 5-5, illustrating the first clamp mechanism having a stanchion and an actuator that is moved to a clamped position for gripping the first rail and holding the crossbar in a fixed position on the rails.

FIG. 6 is a cross-sectional view of the first clamp mechanism of FIG. 2 as taken along line 6-6, illustrating the stanchion having a pair of opposing grooves and the actuator including a cam body pivotably mounted to a pin that in turn has a pair of opposing ends received in the grooves, with the pin moved to an upper position in the grooves in response to the cam body rotating to the clamped position.

FIG. 7 is a cross-sectional view of the first clamp mechanism of FIG. 2 as taken along line 5-5, illustrating the actuator moved to an unclamped position for allowing the crossmember assembly to move along the rails.

FIG. 8 is a cross-sectional view of the first clamp mechanism of FIG. 2 as taken along line 6-6, illustrating the pin moved to a lower position in the grooves in response to the cam body rotating to the unclamped position.

FIG. 9 is a flow chart of one example of a method for operating the assembly of FIG. 1.

### DETAILED DESCRIPTION

The following description is merely exemplary in nature and is not intended to limit the present disclosure, application, or uses. Although the drawings represent examples, the drawings are not necessarily to scale and certain features may be exaggerated to better illustrate and explain a particular aspect of an illustrative example. Any one or more of these aspects can be used alone or in combination within one another. Further, the exemplary illustrations described herein are not intended to be exhaustive or otherwise limiting or restricting to the precise form and configuration shown in the drawings and disclosed in the following detailed description. Exemplary illustrations are described in detail by referring to the drawings as follows:

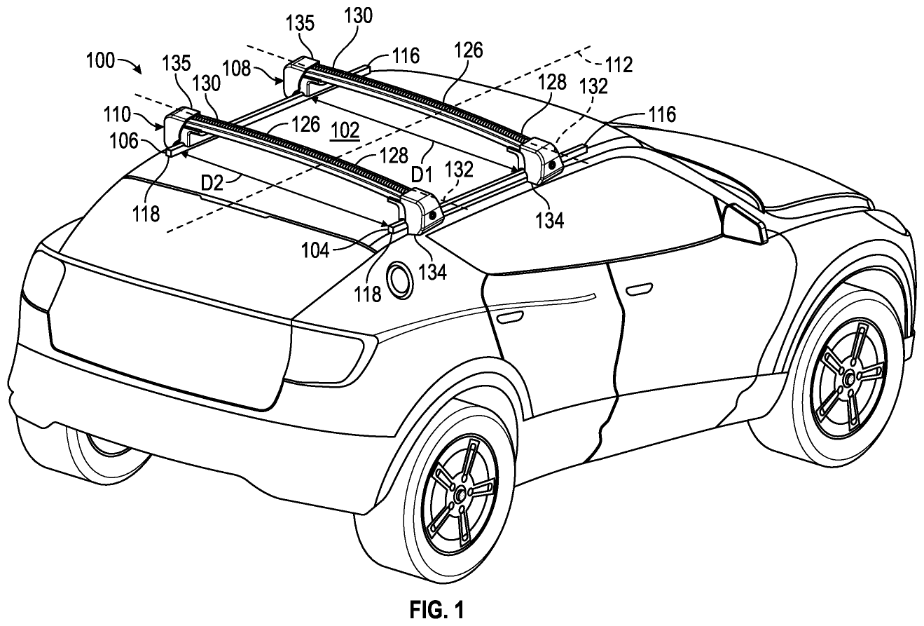

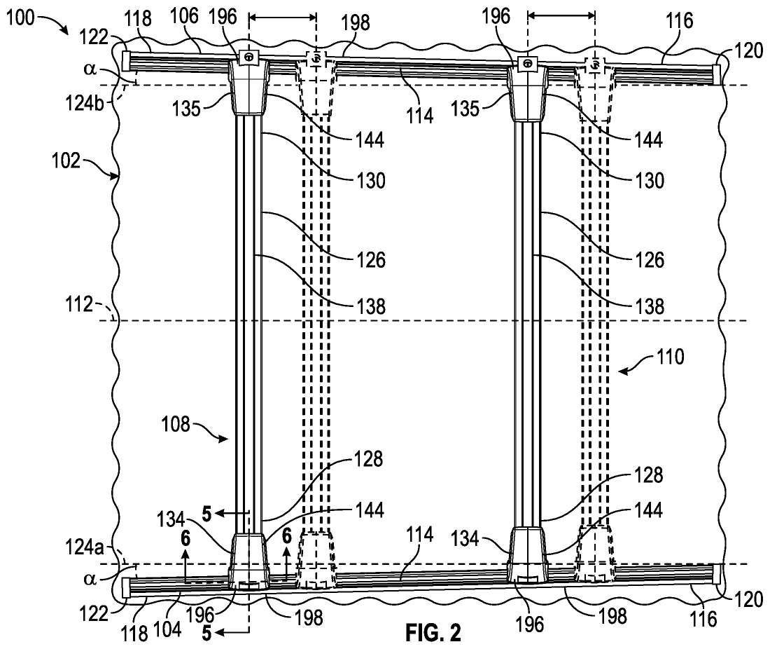

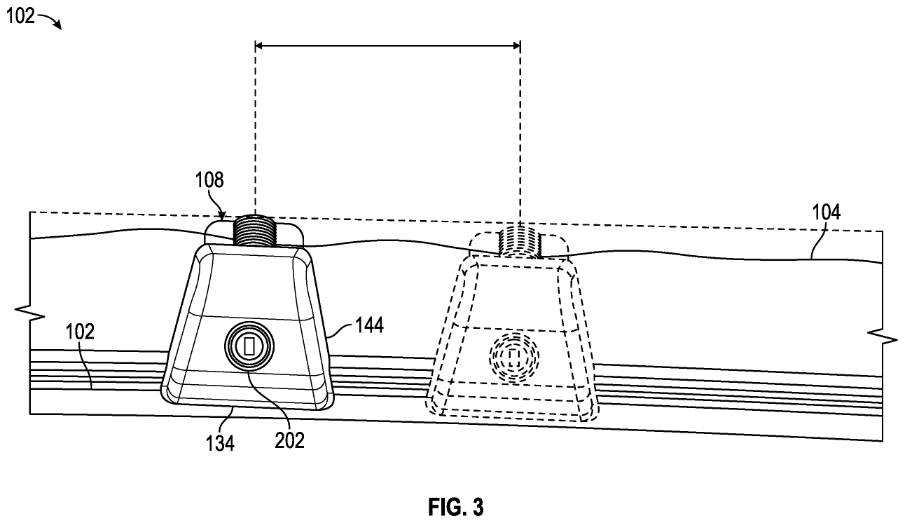

Referring to FIGS. 1 and 2, there is generally shown one example of a motor vehicle 100 having a roof 102 with first and second rails 104, 106 and two crossmember assemblies 108, 110 (“assemblies”) engaging the first and second rails 104, 106. As described in detail below, each assembly 108, 110 has a robust construction that is movable along the rails (FIGS. 2 and 3), is configured to attach to rails that are spaced from one another by a distance within a range of distances, and is configured to grip rails having a width within a range of widths. One non-limiting benefit of the robust construction of the assembly 108, 110 is that it is capable of being integrated within vehicles of different makes, models, and trims. While this non-limiting example of the vehicle 100 includes two assemblies 108, 110 that are identical to one another, it is contemplated that the vehicle 100 can have more or fewer than two assemblies, and those assemblies can be different from one another.

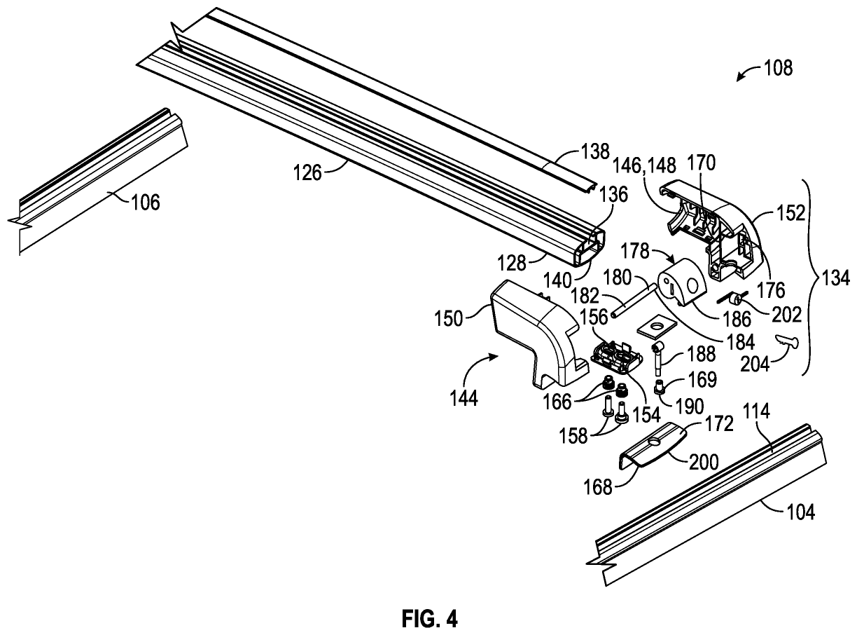

Each of the first and second rails 104, 106 is disposed about a longitudinal centerline 112 of the vehicle 100. In this non-limiting example, as best shown in FIGS. 2 and 4, each of the first and second rails 104, 106 is an extrusion that defines an open channel 114 extending between front and rear ends 116, 118. Each of the first and second rails 104, 106 includes a pair of end caps 120, 122 (FIG. 2) attached to an associated one of the ends 116, 118 to block the open channel 114 and prevent the assemblies 108, 110 from being entirely removed from the rails 104, 106. As also shown in FIG. 2, the first and second rails 104, 106 are angularly spaced a predetermined angle α relative to the longitudinal centerline 112 and reference lines 124a, 124b parallel to same. As shown in FIG. 1, the front ends 116 of the first and second rails 104, 106 are spaced from one another by a front end distance D1. The rear ends 118 of the first and second rails 104, 106 are spaced from one another by a rear end distance D2, which is shorter than the front end distance D1. It is contemplated that the rear ends of the rails can be spaced from one another by a distance, which is longer than the distance by which the front ends are spaced from one another. In still other non-limiting examples, the rails can be linear or arranged parallel with one another. As shown in FIG. 3, the exemplary rails 104, 106 can follow the roof 102 and have a profile that curves vertically toward the front of the vehicle, such that positioning the assembly 108 toward the front ends 116 of the rails 104, 106 can dispose the assembly 108 at a position that is vertically above or below the other assembly 110. However, it is contemplated that the rails can be linear or have other suitable profiles.

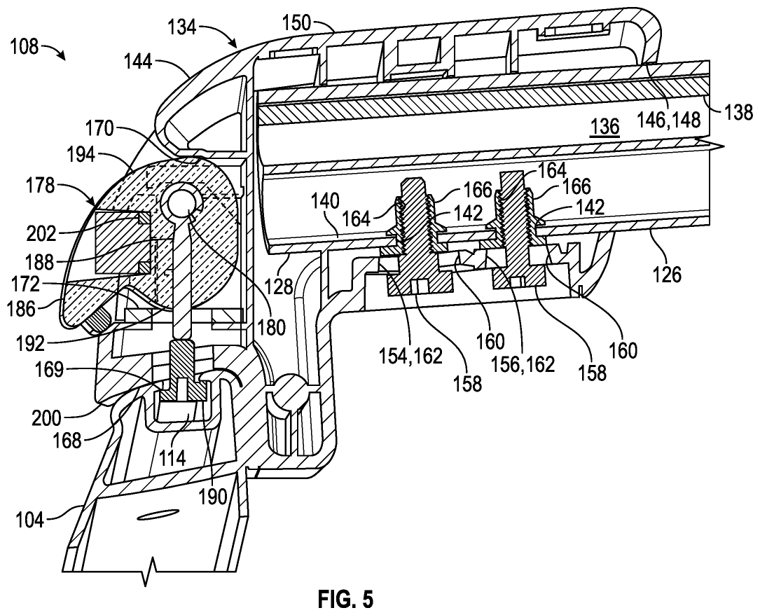

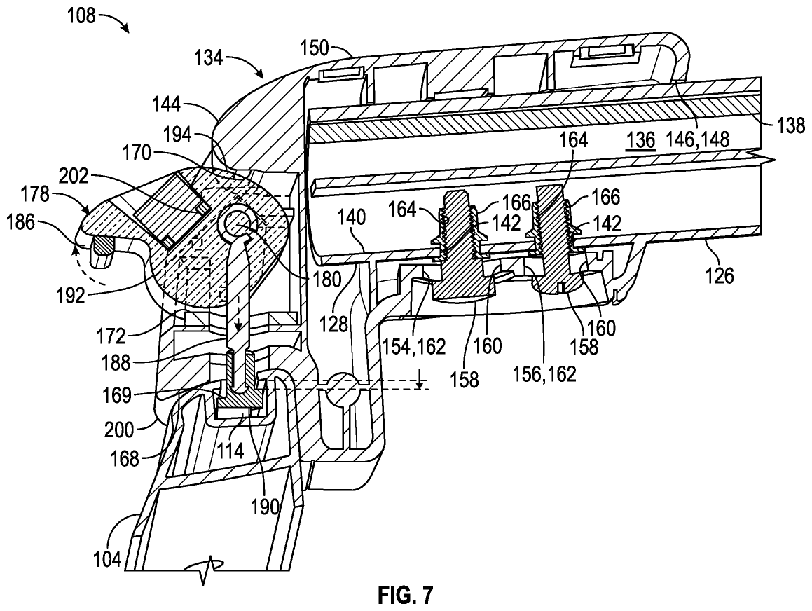

Referring again to FIGS. 1 and 2, each assembly 108, 110 includes a crossbar 126 having first and second ends 128, 130 along an axis 132. The exemplary crossbar 126 is an extrusion (best shown in FIGS. 4 and 5) that defines an upper groove 136 for receiving a trim insert 138. The crossbar 126 further defines a lower wall 140 defining one or more apertures 142 (FIGS. 5 and 7). In this example, the lower wall 140 defines two apertures 142. However, in other non-limiting examples, the lower wall 140 can include more or fewer than two apertures. While FIGS. 5-8 illustrate enlarged cross-sectional views of only the first end 128 of the crossbar 126, the first and second ends 128, 130 of the crossbar 126 are identical to one another. In other non-limiting examples, the first and second ends of the crossbar can be different from one another.

Referring generally to FIGS. 4-8, each assembly 108 further includes a first clamp mechanism 134 attached to the first end 128 of the crossbar 126 for securing the first end 128 to the first rail 104. Each assembly 108, 110 further includes a second clamp mechanism 135 (FIGS. 1 and 2) attached to the second end 130 of the crossbar 126 for securing the second end 130 to the second rail 106. While FIGS. 4-8 illustrate multiple views of only the first clamp mechanism 134 as described in detail below, the second clamp mechanism 135 and the second end 130 of the crossbar 126 are identical to the first clamp mechanism 134 and the first end 128 of the crossbar 126. The second clamp mechanism 135 and the second end 130 of the crossbar 126 have the same components identified by the same numbers increased by 100. In other non-limiting examples, the second clamp mechanism and second end of the crossbar can be different from the first clamp mechanism and first end of the crossbar.

The first clamp mechanism 134 is movable along the axis 132 of the crossbar 126, such that the crossbar 126 is capable of mounting to the first and second rails 104, 106 that are spaced from one another by any distance within the range of distances. More specifically, in this non-limiting example, the first clamp mechanism 134 further includes a stanchion 144 having a collar portion 146 that defines a socket 148 for receiving and attaching to the crossbar 126. The stanchion 144 is displaceable along the axis 132 of the crossbar 126. The stanchion 144 includes first and second clamshell portions 150, 152 that are attached to one another to form the collar portion 146. However, it is contemplated that the stanchion can have any number of parts formed by 3D manufacturing, extrusion, or other suitable manufacturing processes. The collar portion 146 defines one or more elongated slots 154, 156 (FIGS. 5 and 7) capable of receiving an associated threaded fastener 158 that engages internal threading formed in the crossbar 126 for holding the first and second clamp mechanisms 134, 135 at the distance within the range of distances from one another. In this way, the crossbar 126 is capable of mounting to any rails that are spaced from one another by any distance within the range of distances, e.g., associated with the length of the elongated slots 154, 156. Each elongated slot 154, 156 extends between an inboard end 160 and an outboard end 162, such that the first clamp mechanism 134 can be moved in an outboard direction until the fastener 158 abuts the outboard end 162 of the elongated slot 154,156 or in an inboard direction until the fastener 158 abuts the inboard end 160 of the elongated slot 154,156. In this non-limiting example, the internal threading 166 is formed on an internally threaded nut 168 attached to the crossbar 126. However, it is contemplated that the internal threading can be formed integrally formed in the aperture of the crossbar. As detailed below, the stanchion 144 of each of the first and second clamp mechanisms 134, 135 further includes a first rail gripping surface 168, an upper surface 170, a lower surface 172, and a pair of opposing grooves 174, 176 that facilitate with moving an actuator 178 between clamped and unclamped positions.

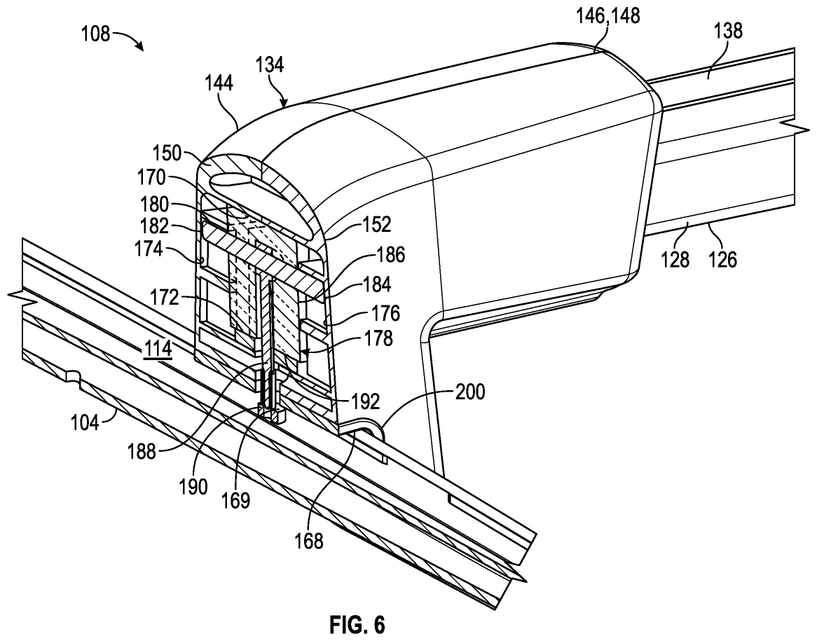

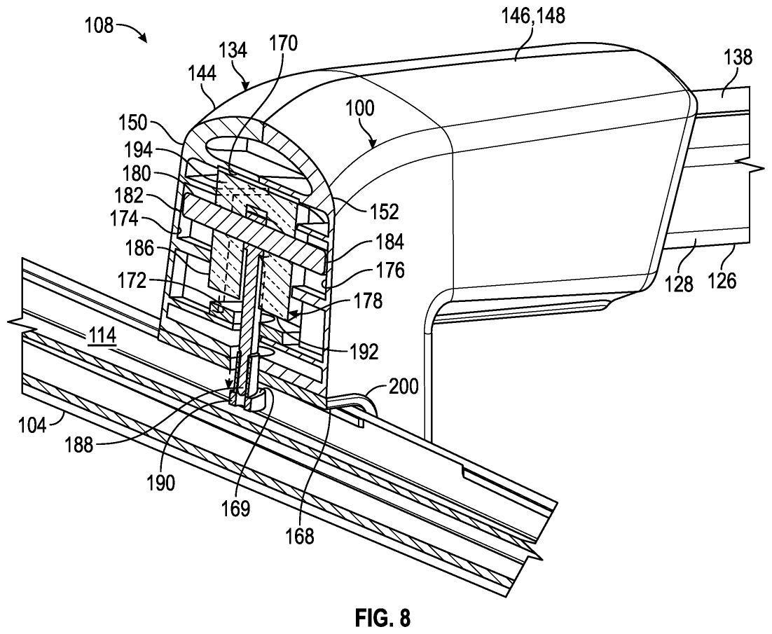

Referring again to FIGS. 4-8, each of the first and second clamp mechanisms 134, 135 includes first and second rail gripping surfaces 168, 169 for gripping an associated one of the rails 104, 106 and securing the crossbar 126 to the rails 104, 106. In this non-limiting example, the stanchion 144 has the first rail gripping surface 168, and the first clamp mechanism 134 further includes the actuator 178, which is attached to the stanchion 144 and has the second rail gripping surface 169. The actuator 178 is movable between the clamped position (FIGS. 5 and 6) where the first and second rail gripping surfaces 168, 169 grip the first rail 104 of any width therebetween to hold the crossbar 126 at a fixed position along the rails and the unclamped position (FIGS. 7 and 8) where the second rail gripping surface 169 is spaced from the first rail 104 such that the crossbar 126 is movable along the rails 104, 106. More specifically, as shown in FIGS. 6 and 8, this non-limiting example of the actuator 178 includes a pin 180 having a pair of opposing ends 182, 184 received within an associated one of the opposing grooves 174, 176 of the stanchion 144, such that the pin 180 is movable between an upper position (FIG. 6) and a lower position (FIG. 8) within the grooves 174, 176.

The actuator 178 further includes a cam body 186 pivotably attached to the stanchion 144 via the pin 180 and a tongue 188 rotatably attached to the cam body 186. The tongue 188 includes a head 190, which has the second rail gripping surface 169 and is positioned in the open channel 114 of the first rail 104. The cam body 186 includes a bottom surface 192 and is movable to the clamped position (FIGS. 5 and 6) where the lower surface 172 of the stanchion 144 engages the bottom surface 192 of the cam body 186 and urges the cam body 186 and the pin 180 in an upward direction which in turn causes the first and second rail gripping surfaces 168, 169 to grip the first rail 104 therebetween for securing the crossbar in the fixed position relative on the first and second rails 104, 106. The cam body 186 further includes a top surface 194 and is movable to the unclamped position (FIGS. 7 and 8) where the upper surface 170 of the stanchion 144 engages the top surface 194 of the cam body 186 and urges the cam body 186 and the pin 180 in a downward direction which in turn causes the second rail gripping surface 169 to be spaced from the first rail 104 for moving the crossbar 126 along the rails. As shown in FIG. 2, one non-limiting benefit of the second rail gripping surface 169 being positioned within the open channel 114 of the associated rails 104, 106 is that the first and second clamp mechanisms 134, 135 can terminate at an outboard edge 196 that overlaps or is disposed inboard relative to an outboard side 198 of the associated rails 104, 106. However, it is contemplated that any one of the first and second clamp mechanisms can extend outboard relative to the outboard side of the rails.

Referring to FIGS. 4-8, the first clamp mechanism 134 further includes one or more modular pads 200 attached to the stanchion 144. Each modular pad 200 has a thickness within a range of thicknesses and a profile within a range of profiles, such that the modular pad cooperates with the stanchion 144 for gripping the first and second rails 104, 106 each having one of the range of widths and one of a range of shapes. In this example, the modular pad 200 is attached to the stanchion 144 of the first clamp mechanism 134 and defines the first rail gripping surface 168. However, it is contemplated that the assembly may have two or more modular pads attached to any portion of the assembly or not have any modular pads.

The first clamp mechanism 134 further includes a lock 202 attached to the cam body 186. The lock 202 is movable between a locked position where the lock engages the stanchion to hold the cam body 186 in the clamped position relative to the stanchion 144 and an unlocked position where the cam body 186 is movable between the clamped and unclamped positions. The first clamp mechanism 134 further includes a key 204 for moving the lock 202 between the unlocked and locked states.

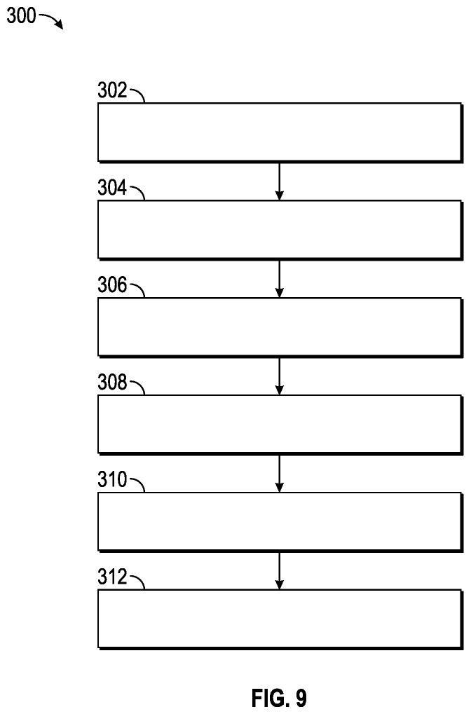

Referring now to FIG. 9, a process 300 is provided for operating the assemblies 108, 110 of FIG. 1. The process 300 begins at block 302 with the actuator 178 of each of the first and second clamp mechanisms 134, 135 moving from the clamped position (FIGS. 5 and 6) to the unclamped position (FIGS. 7 and 8) relative to the stanchion 144. In this non-limiting example, a user pivots the cam body 186 on the pin 180 from the clamped position to the unclamped position, which causes the upper surface 170 of the stanchion 144 to engage the top surface 194 of the cam body 186 and urge the cam body 186 and pin 180 in the downward direction from the upper position to the lower position in the grooves 174, 176.

At block 304, the second rail gripping surface 169 of the first and second clamp mechanisms 134, 135 is spaced from the associated first and second rails 104, 106 in response to the cam body 186 being moved to the unclamped position and the pin 180 moving to the lower position in the grooves 174, 176. Continuing with the previous example, the head 190 of the tongue 188 is moved downward and away from an inwardly facing surface of the rail 104, 106.

At block 306, the user moves the crossbar 126 from a first position to a second position along the first and second rails 104, 106 where, for example, the crossbar 126 is positioned to support cargo on the roof of the motor vehicle. In other non-limiting examples, the roof rack can include one or more motors (not shown) that are attached to the rails for moving the rails between the first and second positions and/or attached to the stanchions for moving the stanchions inboard or outboard along the axis of the crossbar.

At block 308, the user moves the actuator 178 of each of the first and second clamp mechanisms 134, 135 from the unclamped position to the clamped position, in response to the crossbar moving to the second position. In this non-limiting example, the user rotates the cam body 186 from the unclamped position to the clamped position where the lower surface 172 of the stanchion 144 engages the bottom surface 192 of the cam body 186 and urges the cam body 186 and the pin 180 in the upward direction from the lower position to the upper position in the grooves.

At block 310, the first and second rail gripping surfaces 168, 169 of the first and second clamp mechanisms 134, 135 grip an associated one of the first and second rails 104, 106 therebetween, in response to the cam body 186 being moved to the clamped position and the pin 180 moving to the upper position in the grooves 174, 176. Continuing with the previous example, the head 190 of the tongue 188 is moved upward and toward the rail such that the extruded rail is gripped between the second rail gripping surface 169 of the head 190 and the first rail gripping surface 168 of the stanchion 144 for holding the crossbar 126 in the second position on the rails 104, 106.

At block 312, the user inserts the key 204 into the lock 202 and rotates the key 204 to move the lock 202 from the unlocked position to the locked position where the lock 202 holds the cam body 186 in the clamped position relative to the stanchion 144.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The description of the present disclosure is merely exemplary in nature and variations that do not depart from the gist of the present disclosure are intended to be within the scope of the present disclosure. Such variations are not to be regarded as a departure from the spirit and scope of the present disclosure.

1. A crossmember assembly for a motor vehicle having a roof with first and second rails attached to the roof, and each of the first and second rails having one of a range of widths and spaced from one another by one of a range of distances, the crossmember assembly comprising:
a crossbar having first and second ends along an axis;
a first clamp mechanism engaged with the first end of the crossbar for securing the crossbar to the first rail; and
a second clamp mechanism engaged with the second end of the crossbar for securing the crossbar to the second rail;
wherein each of the first and second clamp mechanisms comprises:
a stanchion attached to the crossbar and having a first rail gripping surface; and
an actuator having a second rail gripping surface and is movable relative to the stanchion between a clamped position where the first and second rail gripping surfaces of the first and second clamp mechanisms grip an associated one of the first and second rails and an unclamped position where the second rail gripping surface is spaced from an associated one of the first and second rails such that the crossbar is movable along the first and second rails;
wherein the actuator comprises:
a cam body pivotably attached to the stanchion and movable between the unclamped position where the stanchion urges the cam body in a downward direction and the clamped position where the stanchion urges the cam body in an upward direction; and
a tongue pivotably attached to the cam body and having the second rail gripping surface, with the tongue adapted to be positioned within an open channel formed in an associated one of the first and second rails, with the first and second rail gripping surfaces of the first and second clamp mechanisms capable of gripping an associated one of the first and second rails therebetween to secure the crossbar in a fixed position relative to the first and second rails.

2. (canceled)

3. The crossmember assembly of claim 1 wherein the stanchion defines a pair of grooves, and the actuator further includes a pin having a pair of opposing ends that are received in an associated one of the grooves, with the cam body being pivotably attached to the stanchion via the pin, and the pin having a pair of opposing ends movable relative to the stanchion between an upper position and a lower position.

4. The crossmember assembly of claim 3 wherein at least one of the first and second clamp mechanisms is movable along the axis of the crossbar, such that the crossbar is capable of mounting to the first and second rails that are spaced from one another by one of the range of distances.

5. The crossmember assembly of claim 4 wherein at least one of the crossbar and the stanchion of the first and second clamp mechanisms defines a slot extending along the axis of the crossbar such that a fastener is received through the slot to hold the first and second clamp mechanisms at one of the range of distances from one another.

6. The crossmember assembly of claim 5 wherein each of the first and second clamp mechanisms further comprises a modular pad attached to the stanchion for gripping an associated one of the first and second rails.

7. The crossmember assembly of claim 6 wherein each of the first and second clamp mechanisms further includes a lock attached to the cam body, with the lock movable between a locked position where the lock holds the cam body in the clamped position relative to the stanchion and an unlocked position where the cam body is movable between the clamped and unclamped positions.

8. An adjustable roof rack of a motor vehicle having a roof, the adjustable roof rack comprising:
first and second rails attached to the roof, with each of the first and second rails having one of a range of widths and spaced from one another by one of a range of distances; and
a crossmember assembly comprising:
a crossbar having first and second ends along an axis;
a first clamp mechanism engaged with the first end of the crossbar for securing the crossbar to the first rail; and
a second clamp mechanism engaged with the second end of the crossbar for securing the crossbar to the second rail;
wherein each of the first and second clamp mechanisms comprises:
a stanchion attached to the crossbar and having a first rail gripping surface;
an actuator having a second rail gripping surface and is movable relative to the stanchion between a clamped position where the first and second rail gripping surfaces of the first and second clamp mechanisms grip an associated one of the first and second rails and an unclamped position where the second rail gripping surface is spaced from an associated one of the first and second rails such that the crossbar is movable along the first and second rails;
wherein the actuator comprises:
a cam body pivotably attached to the stanchion and movable between the unclamped position where the stanchion urges the cam body in a downward direction and the clamped position where the stanchion urges the cam body in an upward direction; and
a tongue pivotably attached to the cam body and having the second rail gripping surface, with the tongue adapted to be positioned within an open channel formed in an associated one of the first and second rails, with the first and second rail gripping surfaces of the first and second clamp mechanisms capable of gripping an associated one of the first and second rails therebetween to secure the crossbar in a fixed position relative to the first and second rails.

9. The adjustable roof rack of claim 8 wherein each of the first and second rails is an extrusion defining an open channel extending toward a pair of opposing ends.

10. The adjustable roof rack of claim 9 wherein each of the first and second rails includes a pair of caps attached to an associated one of the opposing ends to block the open channel.

11. (canceled)

12. The adjustable roof rack of claim 8 wherein the stanchion defines a pair of grooves, and the actuator further includes a pin having a pair of opposing ends that are received in an associated one of the grooves, with the cam body being pivotably attached to the stanchion via the pin, and the pin having a pair of opposing ends movable relative to the stanchion between an upper position and a lower position.

13. The adjustable roof rack of claim 12 wherein at least one of the first and second clamp mechanisms is movable along the axis of the crossbar, such that the crossbar is capable of mounting to the first and second rails that are spaced from one another by one of the range of distances.

14. The adjustable roof rack of claim 13 wherein at least one of the crossbar and the stanchion of the first and second clamp mechanisms defines a slot extending along the axis of the crossbar such that a fastener is received through the slot to hold the first and second clamp mechanisms at one of the range of distances from one another.

15. The adjustable roof rack of claim 14 wherein each of the first and second clamp mechanisms further comprises a modular pad attached to the stanchion for gripping an associated one of the first and second rails.

16. The adjustable roof rack of claim 15 wherein each of the first and second clamp mechanisms further includes a lock attached to the cam body, with the lock movable between a locked position where the lock holds the cam body in the clamped position relative to the stanchion and an unlocked position where the cam body is movable between the clamped and unclamped positions.

17. A process of operating a crossmember assembly of an adjustable roof rack for a motor vehicle having a roof, with the adjustable roof rack having first and second rails attached to the roof, and each of the first and second rails having one of a range of widths and spaced from one another by one of a range of distances, and the adjustable roof rack further having a crossmember assembly that comprises a crossbar and first and second clamp mechanisms, with the crossbar having first and second ends along an axis and each of the first and second clamp mechanisms are engaged with an associated one of the first and second ends, each of the first and second clamp mechanisms having a stanchion with a first rail gripping surface and an actuator with a second rail gripping surface, the process comprising:
moving the actuator of each of the first and second clamp mechanisms from a clamped position to an unclamped position relative to the stanchion;
spacing the second rail gripping surface of the first and second clamp mechanisms from an associated on of the first and second rails in response to the actuator moving to the unclamped position;
moving the crossbar from a first position to a second position along the first and second rails;
moving the actuator of each of the first and second clamp mechanisms from the unclamped position to the clamped position in response to the crossbar moving to the second position;
pivoting a cam body of each of the first and second clamp mechanisms between the unclamped position and the clamped position relative to the associated stanchion;
positioning a tongue that is pivotably attached to the cam body and has the second rail gripping surface within an open channel formed in an associated one of the first and second rails, such that the second rail gripping surface is spaced from the associated first and second rails when the actuator is disposed in the unclamped position and the first and second rail gripping surfaces of an associated one of the first and second rail gripping surfaces grip the first and second rails therebetween when the actuator is disposed in the clamped position; and
gripping, using the first and second rail gripping surfaces of the first and second clamp mechanisms, an associated one the first and second rails to hold the crossbar in the second position in response to the actuator moving to the clamped position.

18. (canceled)

19. The process of claim 17 further comprising:
pivoting the cam body on a pin to the clamped position, with the pin having a pair of opposing ends disposed in a pair of associated grooves formed in the stanchion;
moving the pin and the cam body to an upper position along the grooves in response to the cam body pivoting to the clamped position;
gripping an associated one of the first and second rails between the first and second rail gripping surfaces of the first and second clamp mechanisms in response to the pin being disposed in the upper position;
pivoting the cam body on the pin to the unclamped position;
moving the pin and the cam body to a lower position along the grooves in response to the cam body pivoting to the unclamped position; and
spacing the second rail gripping surface from an associated one of the first and second rails in response to the pin being disposed in the lower position.

20. The process of claim 19 further comprising moving a lock that is attached to the cam body and is movable between an unlocked position and a locked position where the lock holds the cam body in the clamped position relative to the stanchion.
